(19) United States
(12) Patent Application Publication
(10) Pub. No.: US 2009/0228317 A1
(43) Pub. Date: Sep. 10, 2009

(54) Method and Apparatus for Determining Minimum Costs

(75) Inventors: Martin Pfeifle, Seewald (DE); Volker Sasse, Lappersdorf (DE); Uwe Tantz, Nittendorf (DE)

Correspondence Address: COHEN, PONTANI, LIEBERMAN & PAVANE LLP, 551 FIFTH AVENUE, SUITE 1210, NEW YORK, NY, 10176, US

(73) Assignee: Continental Automtive GmbH, Hannover (DE)

(21) Appl. No.: 12/226,638

(22) PCT Filed: Apr. 17, 2007
(86) PCT No.: PCT/EP2007/053722

§ 371 Date: Nov. 20, 2008

(30) Foreign Application Priority Data
Apr. 24, 2006 (DE) 10 2006 018 880.2

(51) Int. Cl. G06Q 10/00; G06Q 50/00; G06F 3/048; G06N 5/02

(52) U.S. Cl. 705/7; 715/764; 706/46

(57) ABSTRACT

The aim of the invention is to determine the minimum costs (MIN_KOST) from a starting location (STO) to a destination (ZIO), in order to plan a route on a map (MAP). To achieve this, starting nodes (STK) are determined in accordance with the starting location (STO). Different categories of starting node costs (STK_KOST) from the starting nodes (STK) to at least one predetermined map marker are assigned to the starting nodes (STK). At least the predetermined map marker(s) and the corresponding starting node costs (STK_KOST) of the different categories are determined in accordance with the starting nodes (STK). Destination nodes (ZIK) are determined in accordance with the destination (ZIO). Different categories of destination node costs (ZIK_KOST) from the destination nodes (ZIK) to at least the predetermined map marker are assigned to the destination nodes. The corresponding destination node costs (ZIK_KOST) of the different categories are determined in accordance with the destination nodes (ZIK) and at least the predetermined map marker. The different categories of node costs are weighted differently according to the user's requirements. The minimum costs (MIN_KOST) are determined in accordance with the differently weighted costs.

The invention relates to a method for ascertaining minimum costs from a starting location to a destination for the purpose of planning a route within a map. The starting location is taken as a basis for ascertaining starting nodes, and the destination is taken as a basis for ascertaining destination nodes.

US 2002/0059025 A1 discloses a method for finding a shortest path from a starting location to a destination in a traffic network. This involves the use of a Dijkstra algorithm and a Floyd-Warshal algorithm.

The object of the invention is to provide a method and an apparatus which allow effective route planning.

The object is achieved by the features of the independent claims. Advantageous refinements of the invention are specified in the subclaims.

The invention relates to a method for ascertaining minimum costs from a starting location to a destination. The minimum costs are ascertained for the purpose of planning a route within a map. The starting location is taken as a basis for ascertaining starting nodes. The starting nodes have different associated categories of starting node costs from the starting nodes to at least one prescribed map marker. The starting nodes are taken as a basis for ascertaining at least the one prescribed map marker and the corresponding starting node costs in the different categories. The destination is taken as a basis for ascertaining destination nodes. The destination nodes have different categories of destination node costs from the destination nodes to at least the prescribed map marker associated with them. The destination node and at least the prescribed map marker are taken as a basis for ascertaining the corresponding destination node costs in the different categories. The different categories of the node costs are weighted differently on the basis of a user requirement. The minimum costs are ascertained on the basis of the differently weighted node costs.

This allows, by way of example, speed restrictions, tollbooths and/or dynamic traffic conditions, for example tailbacks, road works and/or commuter traffic, to be taken into account when planning the route. In addition, it allows planning of the route to take account of whether and to what extent a shorter route length for the route or a shorter journey time to cover the route and/or further costs are important to the user.

In one advantageous refinement of the method, the categories comprise spatial costs and/or temporal costs. The spatial costs represent physical distances. The temporal costs represent average journey times required on average in order to cover the corresponding physical distances. This allows particularly effective and precise ascertainment of the minimum costs on the basis of the user requirement.

In another advantageous refinement of the method, the node costs to the map markers are associated only with the nodes which represent gateways via which it is possible to move from one prescribed map detail from the map to another of the prescribed map details from the map. The map is divided into the prescribed map details. If the map details are respectively stored in cohesive memory areas of a storage medium in an appliance for planning the route and/or for ascertaining the minimum distance, this allows only two map details to need to be loaded for planning the route for a respective starting location and a respective destination. Particularly when the memory space requirement is low, particularly in the case of mobile route planners, this may be conducive to allowing sufficiently rapid planning of the route.

In another advantageous refinement of the method, a map detail from the map which comprises a distinguished starting location and/or destination has at least one piece of supplementary information prescribed in it in comparison one of the map details which does not comprise a distinguished starting location and/or destination. The map is divided into the prescribed map details. This allows particularly rapid planning of the route in cases in which the starting location or destination corresponds to the distinguished starting location or destination.

In another advantageous refinement of the method, at least one additional map marker is prescribed as the piece of supplementary information. This may be conducive to particularly rapid planning of the route.

In another advantageous refinement of the method, as the piece of supplementary information, one of the map markers is prescribed such that it corresponds to the distinguished starting location and/or destination. This may be conducive to particularly rapid planning of the route in cases in which the starting location or destination corresponds to the distinguished starting location or destination.

In another advantageous refinement of the method, the starting nodes are taken as a basis for ascertaining starting map markers which are closest to the starting node. The starting nodes have only starting node costs in the different categories to a prescribed first number of starting map markers associated with them. The prescribed first number is smaller than the total number of map markers. The destination node is taken as a basis for ascertaining destination map markers which are closest to the destination node. The destination node has only destination node costs in the different categories to a prescribed second number of destination map markers associated with it. The prescribed second number of destination map markers is smaller than the total number of map markers. The starting node costs and the destination node costs in the different categories are ascertained on the basis of the starting nodes and the starting map markers and on the basis of the destination nodes and the destination map markers. The different categories of map marker costs from the starting map markers to the destination map markers are ascertained using a table. The table comprises the map marker costs in the different categories of all the map markers relative to one another. The different categories of all the ascertained costs are weighted differently on the basis of the user requirement. The minimum costs are ascertained on the basis of the differently weighted destination node costs, starting node costs and on the basis of the ascertained differently weighted map marker costs. This allows a reduction in the volume of data to be stored to the extent that the route, particularly the minimum costs, can be ascertained exclusively with a mobile appliance for planning the route.

The advantageous refinements of the method can readily be transferred to advantageous refinements of the apparatus.

The invention is explained in more detail below with reference to schematic drawings, in which:

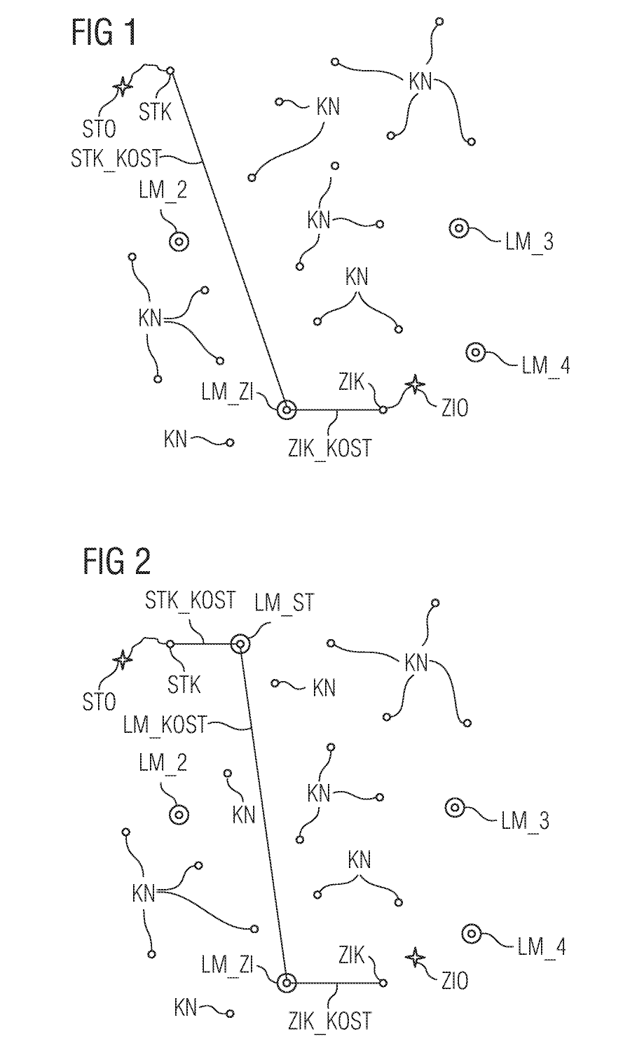

FIG. 1 shows a first view of a map,

FIG. 2 shows a second view of the map,

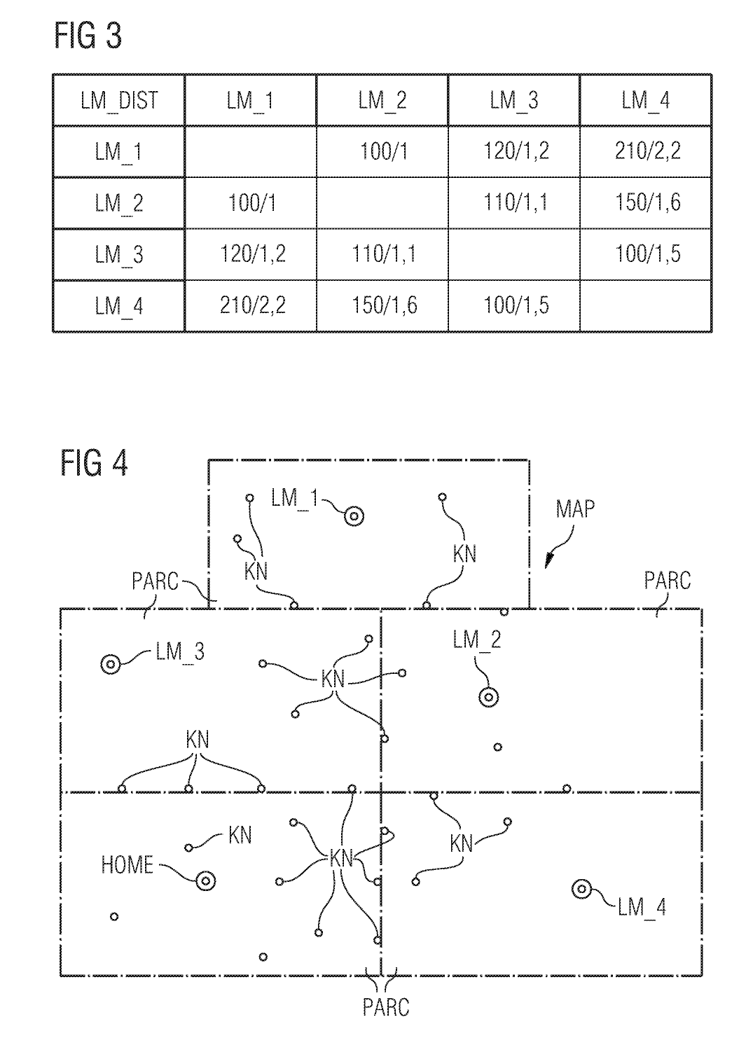

FIG. 3 shows a table with map marker costs,

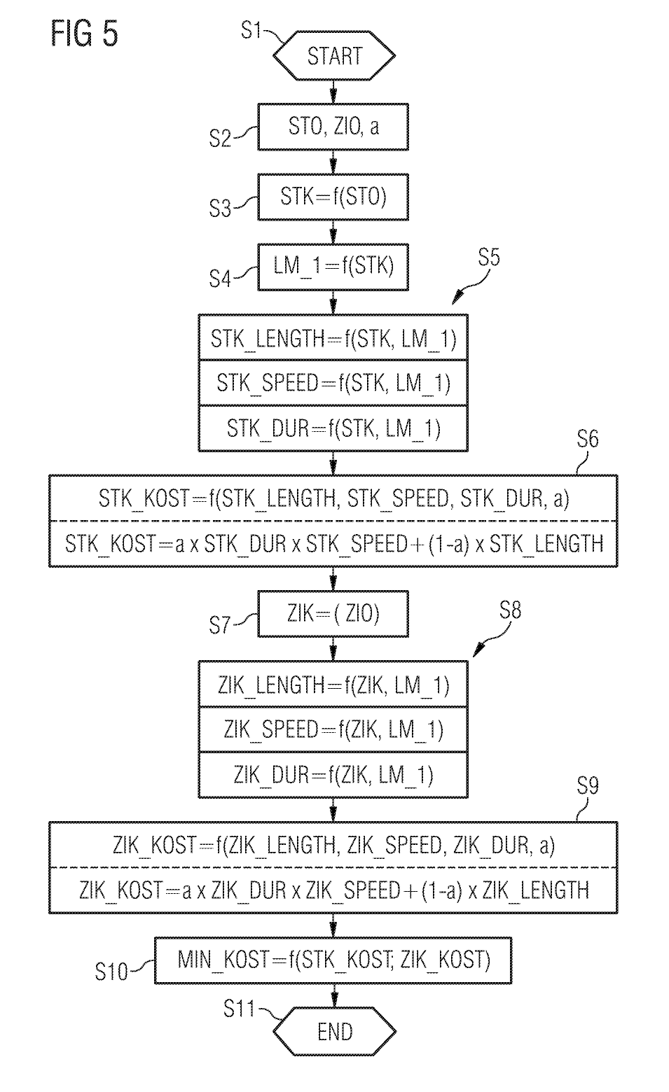

FIG. 4 shows a third view of the map,

FIG. 5 shows a program for ascertaining and weighting minimum costs.

Elements of the same design or function are identified by the same reference symbols across the figures.

A map MAP (FIG. 1) comprises nodes KN, map markers and at least one starting location STO and at least one destination ZIO. The map markers comprise at least first to fourth map markers LM 1-LM 4. The nodes KN comprise at least one starting node STK and a destination node ZIK. Preferably, each of the nodes KN represents a road junction.

The nodes KN have associated node costs up to the map markers. In this context, associated may mean, by way of example, that a storage medium on which the map MAP is stored respectively stores one of the nodes KN and the corresponding node costs in a cohesive memory area of the storage medium. This is particularly advantageous, since when the node KN is loaded for the purpose of ascertaining a route and/or minimum costs MIN_KOST which are required for the route, the corresponding node costs are then also automatically loaded. This means that no additional time is required in order to ascertain the node costs.

The nodes KN comprise at least one, preferably a plurality of starting nodes STK and one, preferably a plurality of destination nodes ZIK. The starting nodes STK represent the nodes KN which are closest to the starting location STO. The starting nodes STK have starting node costs STK_KOST at least to the first to fourth map markers LM_1-LM_4. The destination nodes ZIK represent the closest nodes KN to the destination ZIO. The destination nodes ZIK have destination node costs ZIK_KOST at least to the first to fourth map markers LM_1 to LM_4.

The costs comprise the node costs and the minimum costs MIN_KOST. The node costs comprise the starting node costs STK_KOST, the destination node costs ZI_KOST and further node costs from another of the nodes KN to the first to fourth map markers LM_1-LM_4. By way of example, the costs are representative of physical distances between the nodes and the map markers, of physical distances between the map markers themselves, of journey times required on average in order to cover the physical distances, of speed restrictions and/or of tollbooths. The minimum costs MIN_KOST are representative of the minimum costs required in order to get from the starting location STO to the destination ZIO. Ascertaining the minimum costs MIN_KOST can greatly restrict a search area when searching for a route and can therefore greatly speed up the planning of the route.

The route planning takes account not only of either the spatial costs, the temporal costs or the other costs, but rather all of them at the same time. To this end, it is particularly advantageous for the user himself to be able to weight how important it is to him to optimize the route in terms of journey time, route length to be covered and/or toll charges, for example. By way of example, weighted costs can be ascertained as a function of the journey time, a theoretical average speed of the motor vehicle, the route length and a weighting factor a (FIG. 5). The weighting factor a is preferably a percentage variable. The data stored are respectively only the one hundred percent values in association with the corresponding nodes KN, and the individual weighting is effected on the basis of a user requirement from the user in real time during ascertainment of the route, particularly during ascertainment of the minimum costs MIN_KOST. Hence, almost an infinite number of combinations of different weighting possibilities can be provided, even though only a greatly limited volume of data to be stored is used for this purpose.

Preferably, the nodes KN, which represent gateways, have only node costs to a prescribed number of closest map markers associated with them (FIG. 2). In particular, the starting node STK has associated starting node costs STK_KOST to a prescribed first number of closest starting map markers LM_ST, and the destination node ZIK has associated destination node costs ZIK_KOST to a prescribed second number of destination map markers LM_ZI. The starting map markers LM_ST and the destination map markers LM_ZI represent the closest map markers to the starting nodes STK and to the destination nodes ZIK. The prescribed first and second number of closest map markers are preferably far smaller than the total number of all the map markers. By way of example, the first and/or second number of closest map markers may correspond to one to ten percent of all the map markers. The first and/or second number of closest map markers may vary from node KN to node KN, but it may also be the same and/or firmly prescribed for all the nodes KN.

The map marker costs LM_KOST for all the map markers relative to one another are then preferably stored in a table (FIG. 3). The table is preferably stored on a storage medium. By way of example, the map marker costs from the starting map marker LM_ST to the first map marker LM_1 are on average one hundred kilometers and one hour. That is to say that a vehicle covers the one hundred kilometers between the starting map marker LM_ST and the first map marker LM_1 in one hour on average. The table may also be asymmetrical. In this connection, this means that the costs from the starting location STO to the destination ZIO, particularly the costs from the starting map marker LM_ST to the destination map marker LM_ZI, may be different costs than from the destination ZIO to the starting location STO or from the destination map marker LM_ZI to the starting map marker LM_ST. In addition, all the costs are preferably dependent on the direction in which the route is traveled. This can be caused by a one-way street, for example.

Preferably, at least one distinguished starting location and/or destination is prescribed (FIG. 4). Preferably, the distinguished starting location or destination corresponds to a starting location or destination STO, ZIO which a user of the appliance frequently selects to plan the route. The distinguished starting location or destination is then preferably assigned at least one additional map marker, particularly a distinguished map marker HOME. The map marker costs LM_KOST from the distinguished map marker HOME to the other map markers are then stored in the table of map marker costs LM_KOST. In the case of route planning starting from or arriving at the distinguished map marker HOME, the minimum costs MIN_KOST and/or the route can then be calculated very quickly, since the distinguished map marker HOME is representative of the starting node STK or of the destination node ZIK. The starting node costs STK_KOST or the destination node costs ZIK_KOST can then be automatically set equal to zero. By way of example, the distinguished map marker HOME may be representative of a place of work of the user, of a place of residence and/or, by way of example, a favorite leisure facility of the user.

Providing the distinguished starting location and/or destination STO, ZIO with the distinguished map marker HOME can be considered to be a separate aspect of the invention. If the starting location STO or the destination ZIO corresponds to the distinguished map marker HOME and if each node KN has the node costs to all the map markers associated with it then ascertaining the minimum costs MIN_KOST merely requires the destination node costs ZIK_KOST or the starting node costs STK_KOST to be ascertained. If the starting location STO or the destination ZIO corresponds to the distinguished map marker HOME and if each node LN has only the node costs to the closest map markers associated with it then ascertaining the minimum costs MIN_KOST merely requires the destination node costs ZIK_KOST or the starting node costs STK_KOST and the map marker distance LM_KOST from the destination map marker LM_ST to the distinguished map marker HOME to be ascertained using the table of the map marker costs LM_KOST.

The map MAP is preferably divided into map details PARC. Preferably, each of the map details PARC is stored as a cohesive data packet, for example as a binary large object (BLOB), in a cohesive memory area of the storage medium in an appliance. The appliance is suitable for ascertaining a route and particularly for ascertaining minimum costs MIN_KOST within the map MAP.

Ascertainment of the minimum costs MIN_KOST can also be speeded up by equipping the map detail PARC which comprises the distinguished starting location or destination with supplementary information which goes beyond the information with which the map details PARC which comprise no distinguished starting location or destination are equipped. By way of example, the supplementary information may comprise additional map markers, such as the distinguished map marker HOME, the distinguished starting location or destination itself, additional nodes KN on the edge of the relevant map detail PARC with corresponding node costs, and/or further supplementary information.

The volume of data to be stored can be reduced, by way of example, by associating node costs only with the nodes KN which represent gateways from one of the map details PARC to another of the map details PARC. By way of example, the nodes KN which represent the gateways may be situated on or very close to the edges of the relevant map detail PARC. If the map details PARC overlap, the nodes KN may represent the gateways which are situated in the area of overlap of the map details PARC, for example. To ascertain the route, it is then merely necessary to ascertain a starting map detail and a destination map detail from the map details PARC which comprise the starting location STO and the destination ZIO.

Together with the data from the starting map detail, the data from the starting nodes STK which are situated on the edge of the starting map detail are also loaded. With the data in the starting node STK, the starting node costs STK_KOST are preferably also loaded. If the destination map detail contains one of the map markers then only the costs from the destination ZIO to the relevant map marker then need to be ascertained. If none of the map markers is situated in the destination map detail, for example, then the destination ZIO can be taken as a basis for ascertaining the destination nodes ZIK which are situated on the edge of the destination map detail and which have the node costs at least up to the relevant map marker associated with them. The map details PARC which comprise the first to fourth map markers LM_1-LM_4 do not need to be loaded, since the node costs are preferably associated with the first to fourth map markers LM_1-LM_4 and the starting and destination nodes STK, ZIK.

A program (FIG. 5) for ascertaining the minimum costs MIN_KOST is preferably stored on the storage medium in the appliance for ascertaining the route. By way of example, the appliance may be a PC, a laptop, a pocket computer, a route planning system and/or a navigation system. The appliance can also be referred to as an apparatus for ascertaining the minimum costs from the starting location STO to the destination ZIO for planning the route from the starting location STO to the destination ZIO within a map MAP. The program is preferably started upon a search request from the user of the appliance for the route from the starting location STO to the destination ZIO in a step S1. In the step S1, variables are initialized if appropriate.

In a step S2, the starting location STO, the destination ZIO and the weighting factor a are captured, which have been input and stored by the user. By way of example, a may be equal to 20 percent representative of the route, particularly the minimum costs MIN_KOST, needing to be optimized at 20 percent for the journey time and at 80 percent for the route length.

In a step S3, the starting location STO is taken as a basis for ascertaining the starting nodes STK.

In a step S4, the starting nodes STK are taken as a basis for ascertaining at least one of the map markers, for example the first map marker LM_1. Alternatively, a plurality of the map markers can also be ascertained.

In a step S5, the different categories of starting node costs STK_KOST are ascertained. The starting node costs STK_KOST comprise the route lengths STK_LENGTH from the starting nodes STK to the map markers, the theoretical average speeds STK_SPEED at which it is possible to travel from the starting node STK to the map markers, and/or the journey times STK_DUR required on average in order to get from the starting nodes STK to the map markers. The theoretical average speed STK_SPEED reflects the average speed on various paths from the starting node STK to one of the map markers. Alternatively, the costs may also comprise other categories, for example financial costs, for example on the basis of tollbooths.

In a step S6, the weighted starting node costs STK_KOST are ascertained on the basis of the route lengths STK_LENGTH from the starting nodes STK to the map markers, on the basis of the theoretical average speeds STK_SPEED at which it is possible to travel from the starting node STK to the map markers, or on the basis of the journey times STK_DUR required on average in order to get from the starting nodes STK to the map markers, and on the basis of the weighting factor a. The weighted starting node costs STK_KOST are preferably ascertained using the computation code shown in step S6.

In a step S7, the destination ZIO is taken as a basis for ascertaining the destination nodes ZIK.

In a step S8, the different categories of destination node costs ZIK_KOST are ascertained. The destination node costs ZIK_KOST comprise the route lengths ZIK_LENGTH from the destination nodes ZIK to the map markers, the theoretical average speeds ZIK_SPEED at which it is possible to travel from the destination node ZIK to the map markers, and/or the journey times ZIK_DUR required on average in order to get from the destination nodes ZIK to the map markers. Alternatively, the costs may also comprise other categories, for example financial costs, for example on the basis of tollbooths.

In a step S9, the weighted destination node costs ZIK_KOST are ascertained on the basis of the route lengths ZIK_LENGTH from the destination nodes ZIK to the map markers, on the basis of the theoretical average speeds ZIK_SPEED at which it is possible to travel from the destination node ZIK to the map markers, or on the basis of the journey times ZIK_DUR required on average in order to get from the destination nodes ZIK to the map markers, and on the basis of the weighting factor a. The weighted destination node costs ZIK_KOST are preferably ascertained using the computation code shown in step S6.

In a step S10, the weighted minimum costs MIN_KOST are ascertained on the basis of the weighted starting node costs STK_KOST and on the basis of the weighted destination node costs ZIK_KOST. Preferably, the minimum costs MIN_KOST are ascertained by forming differences, which involve the destination node costs ZIK_KOST being deducted from the starting node costs STK_KOST, for all the triples of the ascertained starting nodes STK, destination nodes ZIK and map markers, and by subsequently ascertaining the greatest difference. The greatest difference is representative of the minimum costs MIN_KOST.

In a step S11, the program can be terminated. Preferably, however, the program is restarted. If, by the time the program is restarted, the appliance for planning the route has moved, while traveling on the route, to a different node KN than when the program was first started, this node KN can preferably be used as the new starting location STO and/or as the new starting node STK for ascertaining new minimum costs MIN_KOST.

The invention is not limited to the exemplary embodiments indicated. By way of example, the different exemplary embodiments can be combined with one another. By way of example, a map detail PARC which comprises the distinguished starting location or destination can be provided with the distinguished map marker HOME and/or with other additional map markers and/or with more nodes KN which comprise the costs to the closest map markers. In addition, a plurality of map details PARC can be provided with the additional information, in particular it is possible for a plurality of distinguished map markers HOME to be set.

1.-8. (canceled)

9. A method for determining minimum costs for a route on a map from a starting location to a destination, the method comprising:
determining a plurality of starting nodes based at least in part on the starting location, each of the plurality of starting nodes having an associated starting node cost from the starting node to at least one of a plurality of map markers;
selecting at least one map marker and the corresponding starting node costs based at least in part on the determined starting nodes;
determining a plurality of destination nodes based at least in part on the destination, each of the plurality of destination nodes having an associated destination node cost from the destination node to the at least one map marker;
determining each of the plurality of destination node costs based at least in part on the determined destination nodes;
applying a weighting factor to the starting node costs and the destination costs; and
determining the minimum costs based on the weighted starting node costs and the destination costs.

10. The method according to claim 9, wherein the map is divided into a plurality of map sections and the map marker represents a gateway via which it is possible to move from one map section to another map section.

11. The method according to claim 9, wherein the starting node costs and the destination costs are weighted based on a user requirement.

12. The method according to claim 9, wherein the starting node costs and the destination costs are each at least one of a spatial cost, which represent physical distances, and a temporal cost, which represents an average journey time.

13. The method according to claim 9, further comprising:
dividing the map into a plurality of map sections, wherein a first map section comprises at least one of the starting location, the destination, and at least a first supplementary information and a second map section comprises at least a second supplementary information.

14. The method according to claim 13, wherein the first and second supplementary information are additional map markers.

15. The method according to claim 14, wherein one of the first and second supplementary information corresponds to one of the starting location and the destination.

16. The method according to claim 9, further comprising:
determining starting map markers that are closest to the starting nodes, the starting nodes associated with the starting node costs for a first plurality of starting map markers;
determining destination map markers that are closest to the destination nodes, the destination nodes associated with only destination node costs for a second plurality of destination map markers;
determining the starting node costs based at least in part on the starting nodes and the starting map markers;
determining the destination node costs based at least in part on the destination nodes and the destination map markers;
applying different weighting factors to the map marker costs and the starting and destination node costs based on a user requirement; and
determining the minimum costs based on the differently weighted destination node costs, the differently weighted starting node costs, and the differently weighted map marker costs,
wherein the map marker costs from the starting map markers to the destination map markers are determined using a table which comprises the map marker costs for the map markers relative to one another.

17. The method according to claim 16, wherein the first plurality of starting map markers is smaller than the total number of map markers associated with the starting nodes.

18. The method according to claim 16, wherein the second plurality of destination map markers is smaller than the total number of map markers associated with the destination nodes.

19. An apparatus for determining minimum costs for a route on a map from a starting location to a destination, the apparatus comprising:
a module for determining a plurality of starting nodes based at least in part on the starting location, each of the plurality of starting nodes having an associated starting node cost from the starting node to at least one of a plurality of map markers;
a module for selecting at least one map marker and the corresponding starting node costs based at least in part on the determined starting nodes;
a module for determining a plurality of destination nodes based at least in part on the destination, each of the plurality of destination nodes having an associated destination node cost from the destination node to the at least one map marker;
a module for determining each of the plurality of destination node costs based at least in part on the determined destination nodes;
a module for applying a weighting factor to the starting node costs and the destination costs; and
a module for determining the minimum costs based on the weighted starting node costs and the destination costs.

20. The apparatus according to claim 19, wherein the map is divided into a plurality of sections and the map markers represent gateways via which it is possible to move from one map section to another map section.

21. A method for determining minimum costs for a route on a map from a starting location to a destination, the method comprising:
retrieving the starting location, the destination and a weighting factor;
determining starting nodes based on the starting location;
determining at least one map marker based on the starting nodes;
determining starting node costs associated with the starting nodes;
determining weighted starting node costs;
determining a destination nodes based on the destination;
determining destination node costs associated with the destination nodes;
determining weighted destination node costs; and
determining the minimum costs based on the weighted starting node costs and the weighted destination node costs, wherein the weighted destination node costs are deducted from the weighted starting node costs to determine the minimum cost.

22. The method for determining minimum costs according to claim 21, the method further comprising determining a revised route using one of the starting nodes, the map markers, or the destination nodes as a revised starting location.

23. The method for determining minimum costs according to claim 21, wherein the starting node costs comprise at least one of a route length from the starting nodes to the map markers, a theoretical average speed at which it is possible to travel from the starting node to the map marker, a journey time required to get from the starting node to the map marker, and financial costs.

24. The method for determining minimum costs according to claim 21, wherein the weighted starting node costs are based on the weighting factor and at least one of a route length from the starting nodes to the map markers, a theoretical average speeds at which it is possible to travel from the starting nodes to the map markers, and a journey time required on average to get from the starting nodes to the map markers.

25. The method for determining minimum costs according to claim 21, wherein the destination node costs are based on at least one of a route length from the destination nodes to the map markers, a theoretical average speed at which it is possible to travel from the destination node to the map markers, a journey time required on average in order to get from the destination nodes to the map markers, and a financial cost.

26. The method for determining minimum costs according to claim 21, wherein the weighted destination node costs are based on the weighting factor and at least one of a route length from the destination nodes to the map markers, a theoretical average speed at which it is
